(19) United States
(12) Patent Application Publication
(10) Pub. No.: US 2019/0383272 A1
(43) Pub. Date: Dec. 19, 2019

(54) WIND TURBINE BLADE PROTECTION STRUCTURE AND METHOD OF FORMING SAME

(71) Applicant: MITSUBISHI HEAVY INDUSTRIES, LTD., Tokyo (JP)

(72) Inventors: Naoto MURATA, Tokyo (JP); Yasutaka KIMURA, Tokyo (JP); Eiji KATO, Yokohama-shi (JP)

(21) Appl. No.: 16/190,354

(22) Filed: Nov. 14, 2018

(30) Foreign Application Priority Data
Jun. 15, 2018 (JP) 2018-114335

(51) Int. Cl. F03D 80/30; F03D 1/06

(52) U.S. Cl. CPC F03D 80/30; F03D 1/0675; F05B 2220/30; F05B 2280/6002; F05B 2240/221; F05B 2240/30; F05B 2260/00; F05B 2230/60

(57) ABSTRACT

A wind turbine blade protection structure for protecting a wind turbine blade from lightning includes at least one metal receptor disposed on a blade tip portion of the wind turbine blade such that at least a part of the at least one metal receptor is exposed on a surface of the wind turbine blade; a down-conductor extending along a blade longitudinal direction from the metal receptor to a blade root portion inside the wind turbine blade, the down-conductor being electrically connected to each of the at least one metal receptor; and a metal thin layer disposed so as to cover at least a part of the surface of the wind turbine blade, at least a part of the metal thin layer being electrically connected to the metal receptor. The metal thin layer disposed is arranged along the down-conductor in the blade longitudinal direction of the wind turbine blade.

### TECHNICAL FIELD

This disclosure relates to a wind turbine blade protection structure and a method of forming the same.

### BACKGROUND

Various conventional structures for protecting a wind turbine blade from lightning have been known.

For example, Patent Document 1 discloses a lightning protection system including: a lightning receptor that is provided on a blade surface to be freely accessible; a down-conductor that is made of a conductive material and extends from the lightning receptor to a blade root, within the blade surface; and a conductive layer electrically isolated from the lightning receptor and the down-conductor.

### CITATION LIST

### Patent Literature

Patent Document 1: U.S. Pat. No. 8,888,454 (Specification)

### SUMMARY

The wind turbine blade provided with the metal receptor as described above may be struck by lightning on a portion of the wind turbine blade surface other than the metal receptor. When this happens, the lightning protection system according to Patent Document 1 fails to smoothly guide lightning current.

In view of the above, an object of at least one embodiment of the disclosure is to, even when a portion other than a metal receptor is struck by lightning, smoothly guide the current of the lightning.

(1) A wind turbine blade protection structure according to at least one embodiment of the disclosure is a wind turbine blade protection structure for protecting a wind turbine blade from lightning including:

at least one metal receptor disposed at least on a blade tip portion of the wind turbine blade such that at least a part of the at least one metal receptor is exposed on a surface of the wind turbine blade;

a down-conductor extending along a blade longitudinal direction from the metal receptor to a blade root portion inside the wind turbine blade, the down-conductor being electrically connected to each of the at least one metal receptor; and

a metal thin layer disposed so as to cover at least a part of the surface of the wind turbine blade, at least a part of the metal thin layer being electrically connected to the metal receptor.

The metal thin layer disposed at least on a side of a pressure surface of the wind turbine blade is arranged along the down-conductor in the blade longitudinal direction of the wind turbine blade.

In the above-described configuration (1), the metal receptor is disposed such that at least a part of the at least one metal receptor is exposed on a surface of the wind turbine blade, and the metal thin layer is disposed so as to cover at least a part of the surface of the wind turbine blade, at least a part of the metal thin layer being electrically connected to the metal receptor. Thus, when the metal thin layer is struck by lightning, the resultant lightning current is guided from the metal thin layer to the metal receptor and is guided to the blade root portion through the down-conductor electrically connected to the metal receptor. Thus, even when a portion other than the metal receptor is struck by lightning, the current of the lightning can be smoothly guided. The metal thin layer disposed at least on the side of the pressure surface of the wind turbine blade is arranged along the down-conductor that finally guides the lightning current, and thus a lightning capture rate can be improved.

(2) In some embodiments, in the above-described configuration (1),

the at least one metal receptor may include a plurality of metal receptors disposed at least on: the blade tip portion on the side of the pressure surface of the wind turbine blade; the blade tip portion on a side of a suction surface of the wind turbine blade; and a plurality of locations arranged at an interval along a trailing edge of the wind turbine blade from the blade tip portion, and

the metal thin layer may be disposed within a range not greater than 40% of a blade length of the wind turbine blade along the blade longitudinal direction, from the metal receptor disposed on the blade tip portion on the pressure surface or the suction surface on which the metal thin layer is disposed.

In the above-described configuration (2), the metal thin layer is disposed within a range not greater than 40% of the blade length from the metal receptor disposed on the pressure surface or the suction surface of the wind turbine blade. This configuration with the metal thin layer disposed within a range not greater than 40% of the blade length from the blade tip, which is likely to be struck by lightning, can achieve a high lightning capture rate within the range. Thus, the lightning current of lightning hitting a large portion of the wind turbine blade can be smoothly guided to the blade root portion.

(3) In some embodiments, in the above-described configuration (1) or (2),

the metal thin layer on a side of a suction surface of the wind turbine blade may be disposed closer to a trailing edge with respect to a chord center of the wind turbine blade, within a range not greater than 40% of a blade length from the blade tip portion on the side of the suction surface.

With the above-described configuration (3), the metal thin layer on the side of the suction surface of the wind turbine blade is disposed closer to the trailing edge, less affected by wind than the leading edge, with respect to the chord center. Thus, even when a portion other than the metal receptor is struck by lightning, the current of the lightning can be smoothly guided, while preventing the metal thin layer from peeling off from the wind turbine blade due to wind.

(4) In some embodiments, in the above-described configuration (3),

the metal thin layer on the side of the suction surface of the wind turbine blade may be disposed so as to electrically connect at least a part of the plurality of metal receptors disposed on a plurality of locations arranged at an interval along a leading edge or the trailing edge of the wind turbine blade.

With the above-described configuration (4), the metal thin layer on the side of the suction surface of the wind turbine blade is disposed closer to the trailing edge, less affected by wind than the leading edge. Thus, even when a portion other than the metal receptor is struck by lightning, the current of the lightning can be smoothly guided, while preventing the metal thin layer from peeling off from the wind turbine blade due to wind. Furthermore, the metal thin layer is disposed so as to electrically connect at least a part of the plurality of metal receptors disposed on a plurality of locations arranged at an interval along the trailing edge. Thus, current of the lightning hitting the metal thin layer can be divided to flow through a plurality of paths, so that the metal thin layer can be prevented from melting.

(5) In some embodiments, in the above-described configuration (1),

the at least one metal receptor may include a plurality of metal receptors disposed at least on: the blade tip portion on the side of the pressure surface of the wind turbine blade; the blade tip portion on a side of a suction surface of the wind turbine blade, and a plurality of locations arranged at an interval along a leading edge or a trailing edge of the wind turbine blade from the blade tip portion, and

the metal thin layer on the side of the pressure surface may be disposed within a range not greater than 40% of a blade length from a blade tip of the wind turbine blade including the metal receptor disposed on the blade tip portion, and

the metal thin layer on the side of the suction surface may be disposed within a range smaller than 20% of the blade length along the blade longitudinal direction from the blade tip including the metal receptor disposed on the blade tip portion.

With the above-described configuration (5), the metal thin layer disposed within the range not greater than 40% of the blade length from the blade tip on the pressure surface side of the wind turbine blade can expand a lightning receivable range where the lightning current of lighting within the range can be guided from the metal receptor disposed in the blade tip portion to the down-conductor. Lightning can be appropriately captured by the plurality of metal receptors disposed at an interval along the leading edge or the trailing edge on the side of the suction surface of the wind turbine blade and the metal thin layer disposed within the range of 20% of the blade length from the blade tip including the metal receptor disposed on the blade tip portion.

(6) In some embodiments, in any one of the above-described configurations (1) to (5),

a diverter strip may be disposed on a suction surface of the wind turbine blade, the diverter strip being configured to be capable of electrically connecting two of the at least one metal receptor disposed on a leading-edge side and a trailing-edge side upon lightning strike.

In the above-described configuration (6), the diverter strip is disposed between the two metal receptors disposed on the leading-edge side and the trailing-edge side on the suction surface of the wind turbine blade. Air around this diverter strip is ionized upon lightning strike, and the lightning current flows along the surface of the wind turbine blade via the diverter strip to be guided to the receptor. Thus, no lightning conductor needs to be provided for the diverter strip, whereby lightning resistance performance of the wind turbine blade can be improved with a simple structure.

(7) In some embodiments, in the above-described configuration (5),

a diverter strip may be disposed on a suction surface of the wind turbine blade, the diverter strip being configured to be capable of electrically connecting two of the at least one metal receptor disposed on a leading-edge side and a trailing-edge side upon lightning strike, and

the metal thin layer on the side of the suction surface may be disposed on a position separated from the diverter strip by at least one meter.

With the above-described configuration (7), the diverter strip enables the lightning resistance performance of the wind turbine blade to be improved with a simple structure as described above in relation with the configuration (6). Furthermore, in the above-described configuration (7), the metal thin layer on the side of the suction surface is disposed on a position separated from the diverter strip by at least one meter. This configuration can prevent spark, due to the lightning current jumping to the metal receptor disposed on a portion other than the blade tip portion from the metal thin layer on the side of the suction surface, and the like.

(8) In some embodiments, in the above-described configuration (1),

the at least one metal receptor may include a plurality of metal receptors disposed at least on: the blade tip portion on the side of the pressure surface; the blade tip portion on a side of a suction surface of the wind turbine blade; and a plurality of locations arranged at an interval along a leading edge and a trailing edge of the wind turbine blade from the blade tip portion,

the metal thin layer on the side of the pressure surface may be disposed within a range not greater than 20% of a blade length from a blade tip of the wind turbine blade along the blade longitudinal direction from the metal receptor disposed on the blade tip portion on the side of the pressure surface, and

the metal thin layer on the side of the suction surface may be disposed over a first range where two of the metal receptors disposed on a leading-edge side and a trailing-edge side are electrically connected in a range smaller than 20% of the blade length from the blade tip, and a second range extending along the blade longitudinal direction from the metal receptor disposed on the blade tip portion so as to at least partially overlap with the first range.

With the above-described configuration (8), lightning can be captured by the metal thin layer that is disposed within a range not greater than 20% of the blade length from the blade tip of the wind turbine blade along the blade longitudinal direction from the metal receptor disposed on the blade tip portion on the side of the pressure surface of the wind turbine blade. The resultant lightning current can be guided to the down-conductor through the metal receptor. Furthermore, the lightning capture rate can further be improved with the metal thin layer on the side of the suction surface that is disposed over the first range where two of the metal receptors disposed on the leading-edge side and the trailing-edge side are electrically connected and the second range extending along the blade longitudinal direction from the metal receptor disposed on the blade tip portion so as to at least partially overlap with the first range.

(9) In some embodiments, in any one of the above-described configurations (1) to (8),

the wind turbine blade protection structure may further include a leading-edge side shear web and a trailing-edge side shear web each extending along the blade longitudinal direction inside the wind turbine blade and connecting the pressure surface and a suction surface of the wind turbine blade,

the trailing-edge side shear web may be disposed closer to a center from the leading-edge side shear web in a chordwise direction of the wind turbine blade, the trailing-edge side shear web extending closer to the blade tip than the leading-edge side shear web,

the at least one metal receptor may include a plurality of metal receptors disposed at an interval along each of the leading-edge side and the trailing-edge side of the suction surface, and

the down-conductor may include a first down-conductor disposed along the leading-edge side shear web, and a second down-conductor disposed along the trailing-edge side shear web.

The above-described configuration (9) includes the two down-conductors, namely, the first down-conductor and the second down-conductor, to ensure a plurality of paths for guiding the lightning current along the blade longitudinal direction to be provided in the wind turbine blade. The second down-conductor extends to the blade tip along the trailing-edge side shear web, and may be electrically connected to the metal receptor at the blade tip portion. With this configuration, for example, the metal receptors on the leading-edge side are connected to the first down-conductor and the metal receptors on the trailing-edge side are connected to the second down-conductor, on the side of the suction surface of the wind turbine blade. Thus, the lightning current can be more smoothly guided.

(10) In some embodiments, in any one of the above-described configurations (1) to (9),

the at least one metal receptor may be formed so as to have a protruding height of not greater than 3 mm from a blade surface of the wind turbine blade.

With the above-described configuration (10), the metal receptor has a small impact on the aerodynamics of the wind turbine blade. Thus, the lightning resistance performance can be improved with a small impact on an operation performance of the wind turbine.

(11) In some embodiments, in any one of the above-described configurations (1) to (10),

the metal thin layer may include a metal tape, a metal mesh, or a metal layer.

With the above-described configuration (11), the effect described in relation to any one of the above-described configurations (1) to (10) can be obtained with the metal thin layer including a metal tape, a metal mesh, or a metal layer.

(12) In some embodiments, in any one of the above-described configurations (1) to (11),

the metal thin layer may be formed so as to have an area occupying a blade surface of the wind turbine blade, the area being not smaller than ten times an area of the metal receptor to which the metal thin layer is to be connected.

With the above-described configuration (12), the lightning receivable range of lightning at least in the blade tip portion can be expanded to be not smaller than ten times an area with the metal receptor alone. Thus, the lightning capture rate can be largely improved at the blade tip portion, which is likely to be struck by lightning.

(13) In some embodiments, in any one of the above-described configurations (1) to (12),

the metal thin layer may have a width of from 50 to 300 mm

With the above-described configuration (13), the effect described in relation to any one of the configurations (1) to (12) can be obtained with the metal thin layer having a width of from 50 to 300 mm

(14) In some embodiments, in any one of the above-described configurations (1) to (13),

the metal thin layer may have a thickness of from 50 to 300 μm.

With the above-described configuration (14), the metal thin layer has a thickness of from 50 to 300 μm to have the smallest possible impact on the aerodynamics of the wind turbine blade. Thus, the lightning resistance performance can be improved with a small impact on the operation performance of the wind turbine.

(15) A method of forming a wind turbine blade protection structure according to at least one embodiment of the disclosure is a method of forming a wind turbine blade protection structure for protecting a wind turbine blade from lightning, the method including:

a step of arranging at least one metal receptor at least on a blade tip portion of the wind turbine blade so that at least a part of the metal receptor is exposed on a surface of the wind turbine blade;

a step of arranging a down-conductor electrically connected to each of the at least one metal receptor along a blade longitudinal direction from the metal receptor to a blade root portion inside the wind turbine blade; and

a step of arranging a metal thin layer so as to cover at least a part of a surface of the wind turbine blade so that at least a part of the metal thin layer is electrically connected to the at least one metal receptor.

The step of arranging the metal thin layer includes arranging the metal thin layer disposed at least on a side of a pressure surface of the wind turbine blade along the down-conductor in the longitudinal direction of the wind turbine blade.

In the above-described method (15), as described in (1) above, the metal receptor is disposed such that at least a part of the at least one metal receptor is exposed on a surface of the wind turbine blade, and the metal thin layer is disposed so as to cover at least a part of the surface of the wind turbine blade, at least a part of the metal thin layer being electrically connected to the metal receptor. Thus, when the metal thin layer is struck by lightning, the resultant lightning current is guided from the metal thin layer to the metal receptor and is guided to the blade root portion through the down-conductor electrically connected to the metal receptor. Thus, even when a portion other than the metal receptor is struck by lightning, the current of the lightning can be smoothly guided. The metal thin layer disposed at least on the side of the pressure surface of the wind turbine blade is arranged along the down-conductor that finally guides the lightning current, and thus a lightning capture rate can be improved.

According to at least one embodiment of the disclosure, even when a portion other than the metal receptor is struck by lightning, the current of the lightning can be smoothly guided.

### BRIEF DESCRIPTION OF DRAWINGS

FIG. 1 is a schematic view illustrating a wind turbine power generation facility to which a wind turbine blade protection structure according to one embodiment is applied;

FIG. 2 is a schematic perspective view illustrating a wind turbine blade according to one embodiment;

FIG. 3A and FIG. 3B are schematic views illustrating a configuration example of a wind turbine blade protection structure according to one embodiment, FIG. 3A illustrating a suction surface and FIG. 3B illustrating a pressure surface;

FIG. 4A and FIG. 4B are schematic views illustrating a configuration example of a wind turbine blade protection structure according to another embodiment, FIG. 4A illustrating a suction surface and FIG. 4B illustrating a pressure surface;

FIG. 5A and FIG. 5B are schematic views illustrating a configuration example of a wind turbine blade protection structure according to another embodiment, FIG. 5A illustrating a suction surface and FIG. 5B illustrating a pressure surface;

FIG. 6A and FIG. 6B are schematic views illustrating a configuration example of a wind turbine blade protection structure according to another embodiment, FIG. 6A illustrating a suction surface and FIG. 6B illustrating a pressure surface;

FIG. 7A and FIG. 7B are schematic views illustrating a configuration example of a wind turbine blade protection structure according to another embodiment, FIG. 7A illustrating a suction surface and FIG. 7B illustrating a pressure surface;

FIG. 8 is a schematic view illustrating a configuration example of a wind turbine blade protection structure according to another embodiment; and

FIG. 9 is a flowchart illustrating a method of forming a wind turbine blade protection structure according to another embodiment.

### DETAILED DESCRIPTION

Some exemplary embodiments of the disclosure are described with reference to the accompanying drawings. The size, material, shape, other relative arrangements, and the like described in some embodiments below are not intended to limit the scope of the disclosure to these unless otherwise specified, and are merely illustrative.

For example, expressions that represent relative or absolute arrangements such as “in a direction”, “along a direction”, “parallel”, “perpendicular”, “center”, “concentric”, or “coaxial” refer not only to what exactly these expressions represent but also to states that allow tolerance or are relatively displaced by such a degree of angle or distance that can achieve the same functions.

For example, expressions on shapes such as rectangular or cylindrical refer not only to shapes such as rectangular or cylindrical in a geometrically exact sense but also to such shapes that include protrusions, recesses, chamfered parts, or the like as long as the same functions are available.

Expressions that represent “comprising”, “including”, “being provided with”, “with”, or “having” one component are not exclusive expressions that would exclude the existence of other component(s).

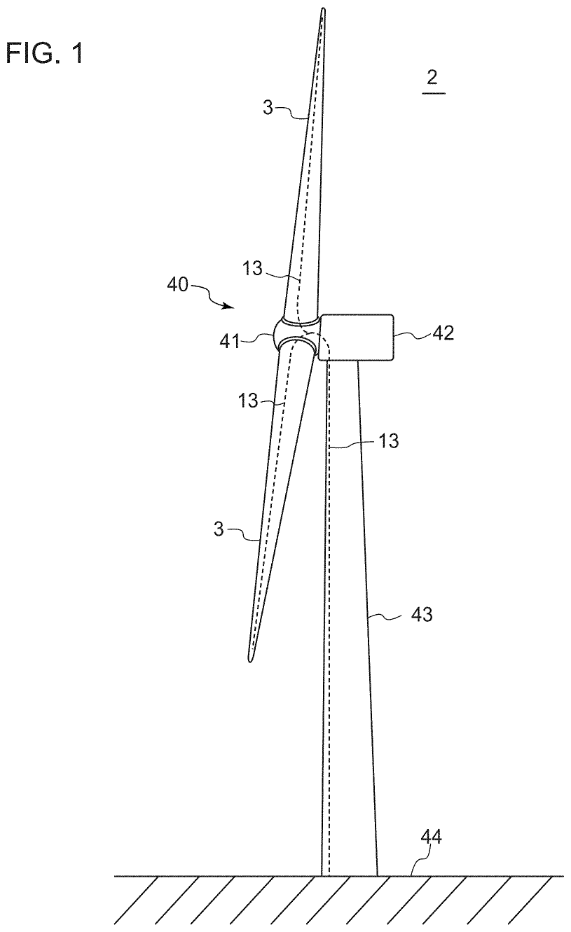

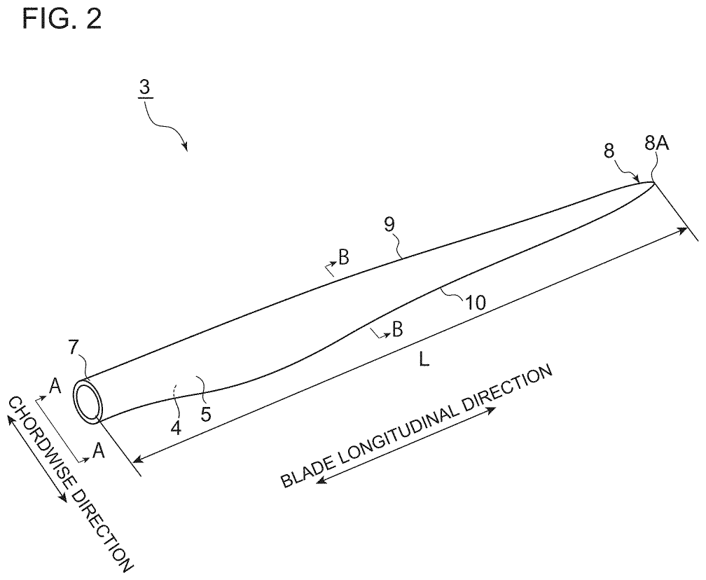

FIG. 1 is a schematic view illustrating a wind turbine power generation facility (wind turbine) to which a wind turbine blade protection structure according to at least one embodiment of the disclosure is applied, and FIG. 2 is a schematic perspective view illustrating a wind turbine blade according to one embodiment.

As illustrated in FIG. 1 and FIG. 2, a wind turbine power generation facility according to at least one embodiment of the disclosure (hereinafter, referred to as a wind turbine 2) includes: a rotor 40 including a plurality of (for example, three) wind turbine blades 3 and a hub 41 to which the wind turbine blades 3 are attached; a nacelle 42 that rotatably supports the rotor 40 via a main shaft and a main bearing (not illustrated); a tower 43 supporting the nacelle 42 yaw-rotatably; and a base 44 on which the tower 43 is installed.

Each of the wind turbine blades 3 extends in a longitudinal direction (blade longitudinal direction) from a blade root portion 7 attached to the hub 41 of the wind turbine 2 to a blade tip portion 8. The wind turbine blade 3 has a leading edge 9 and a trailing edge 10 each extending from the blade root portion 7 to the blade tip portion 8, and has a hollow structure including a pressure surface 4 (also referred to as a positive pressure surface or a ventral surface) and a suction surface 5 (also referred to as a negative pressure surface or a dorsal surface) facing the pressure surface 4.

The “blade longitudinal direction” as used in this specification is a direction between the blade root portion 7 and the blade tip portion 8, and a “chordwise direction (blade chordwise direction)” is a direction along a line (chord) between the leading edge 9 and the trailing edge 10 of the wind turbine blade 3. The “blade root portion” is a cylindrical portion of the wind turbine blade 3, with a substantially circular cross-sectional shape. The blade root portion is within a range of 5 m in the blade longitudinal direction from a blade-root-side end surface (typically within a range of 1 to 3 m from the end surface).

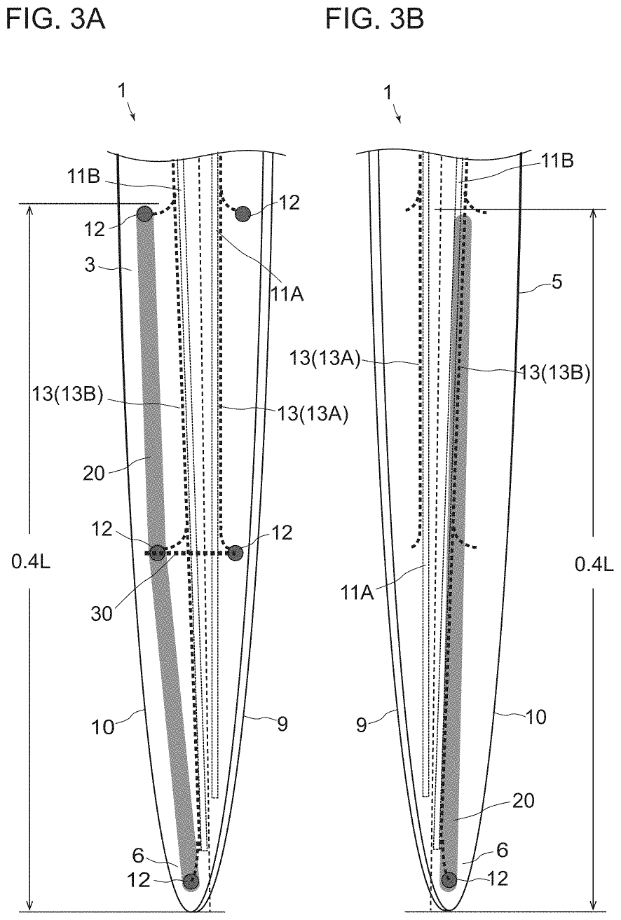

FIG. 3A and FIG. 3B are schematic views illustrating a configuration example of a wind turbine blade protection structure according to at least one embodiment of the disclosure, FIG. 3A illustrating a suction surface and FIG. 3B illustrating a pressure surface.

As illustrated in FIG. 3A and FIG. 3B in a non-limiting manner, a wind turbine blade protection structure 1 according to at least one embodiment of the disclosure is a wind turbine blade protection structure for protecting the wind turbine blade 3 from lightning including: at least one metal receptor 12 disposed at least on the blade tip portion 8 of the wind turbine blade 3 such that at least a part of the at least one metal receptor 12 is exposed on a surface 6 of the wind turbine blade 3; a down-conductor 13 extending along a blade longitudinal direction from the metal receptor 12 to the blade root portion 7 inside the wind turbine blade 3, the down-conductor 13 being electrically connected to each of the at least one metal receptor 12; and a metal thin layer 20 (or a conductive metal film) disposed so as to cover at least a part of the surface 6 of the wind turbine blade 3, at least a part of the metal thin layer 20 being electrically connected to the metal receptor 12.

The metal receptor 12 is a conductive member made of metal (such as a stainless steel material for example), and has a function of receiving lightning hitting the wind turbine blade 3, so that a portion of the wind turbine blade 3 other than the metal receptor 12 is less likely to be struck by lightning.

The down-conductor 13 inside the wind turbine blade 3 is electively connected to the metal receptor 12, and guides lightning current of lightning hitting the metal receptor 12 to a ground terminal through the blade root portion 7, the hub 41, the nacelle 42, and the tower 43 (see FIG. 1).

The metal thin layer 20 is a conductive thin layer made of metal. In some embodiments, the metal thin layer 20 may be adhered on a blade surface 6 of the wind turbine blade 3 with adhesive (adhesion layer). The metal thin layer 20 is electrically connected with the metal receptor 12 on the side of the surface 6 of the wind turbine blade 3 and functions such that the lightning receivable range in which the metal receptor 12 can receive lightning may be expanded.

In the wind turbine blade protection structure 1 according to at least one embodiment of the disclosure, the metal thin layer 20 disposed at least on a side of the pressure surface 4 of the wind turbine blade 3 is arranged along the down-conductor 13 in the blade longitudinal direction of the wind turbine blade 3 (see FIG. 3B).

In the wind turbine blade protection structure 1 according to one embodiment described above, the metal receptor 12 is disposed such that at least a part of the at least one metal receptor 12 is exposed on a surface 6 of the wind turbine blade 3, and the metal thin layer 20 is disposed so as to cover at least a part of the surface 6 of the wind turbine blade 3, at least a part of the metal thin layer 20 being electrically connected to the metal receptor 12. Thus, when the metal thin layer 20 is struck by lightning, the resultant lightning current is guided from the metal thin layer 20 to the metal receptor 12 and is guided to the blade root portion 7 through the down-conductor 13 electrically connected to the metal receptor 12. Thus, even when a portion other than the metal receptor 12 is struck by lightning, the current of the lightning can be smoothly guided. The metal thin layer 20 disposed at least on the side of the pressure surface 4 of the wind turbine blade 3 is arranged along the down-conductor 13 that finally guides the lightning current, and thus a lightning capture rate can be improved.

In some embodiments, the at least one metal receptor 12 may include a plurality of metal receptors 12 disposed at least on: the blade tip portion 8 on the side of the pressure surface 4 of the wind turbine blade 3; the blade tip portion 8 on a side of the suction surface 5 of the wind turbine blade 3; and a plurality of locations arranged at an interval along the trailing edge 10 of the wind turbine blade 3 from the blade tip portion 8 (for example, see FIG. 3A and FIG. 3B).

The metal thin layer 20 may be disposed within a range not greater than 40% of a blade length L of the wind turbine blade 3 along the blade longitudinal direction, from the metal receptor 12 disposed on the blade tip portion 8 on the pressure surface 4 or the suction surface 5 on which the metal thin layer 20 is disposed (for example, see FIG. 3A).

As described above, the metal thin layer 20 is disposed within a range not greater than 40% of the blade length L from the metal receptor 12 disposed on the pressure surface 4 or the suction surface 5 of the wind turbine blade 3. This configuration with the metal thin layer 20 disposed within a range not greater than 40% of the blade length L from a blade tip 8A, which is likely to be struck by lightning, can achieve a high lightning capture rate within the range. Thus, the lightning current of lightning hitting a large portion of the wind turbine blade 3 can be smoothly guided to the blade root portion 7.

In some embodiments, the metal thin layer 20 on a side of the suction surface 5 of the wind turbine blade 3 may be disposed closer to the trailing edge 10 with respect to a chord center of the wind turbine blade 3, within a range not greater than 40% of the blade length L from the blade tip portion 8 on the side of the suction surface 5 (for example, see FIG. 3A).

With this configuration, the metal thin layer 20 on the side of the suction surface 5 of the wind turbine blade 3 is disposed closer to the trailing edge 10, less affected by wind than the leading edge 9, with respect to the chord center. Thus, even when a portion other than the metal receptor 12 is struck by lightning, the current of the lightning can be smoothly guided, while preventing the metal thin layer 20 from peeling off from the wind turbine blade 3 due to wind.

In some embodiments, the metal thin layer 20 on the side of the suction surface 5 of the wind turbine blade 3 may be disposed so as to electrically connect at least a part of the plurality of metal receptors 12 disposed on a plurality of locations arranged at an interval along the leading edge 9 or the trailing edge 10 of the wind turbine blade 3 (for example, see FIG. 3A).

With this configuration, the metal thin layer 20 on the side of the suction surface 5 of the wind turbine blade 3 is disposed closer to the trailing edge 10, less affected by wind than the leading edge 9. Thus, even when a portion other than the metal receptor 12 is struck by lightning, the current of the lightning can be smoothly guided, while preventing the metal thin layer 20 from peeling off from the wind turbine blade 3 due to wind. Furthermore, the metal thin layer 20 is disposed so as to electrically connect at least a part of the plurality of metal receptors 12 disposed on a plurality of locations arranged at an interval along the trailing edge 10. Thus, current of the lightning hitting the metal thin layer 20 can be divided to flow through a plurality of paths, so that the metal thin layer 20 can be prevented from melting.

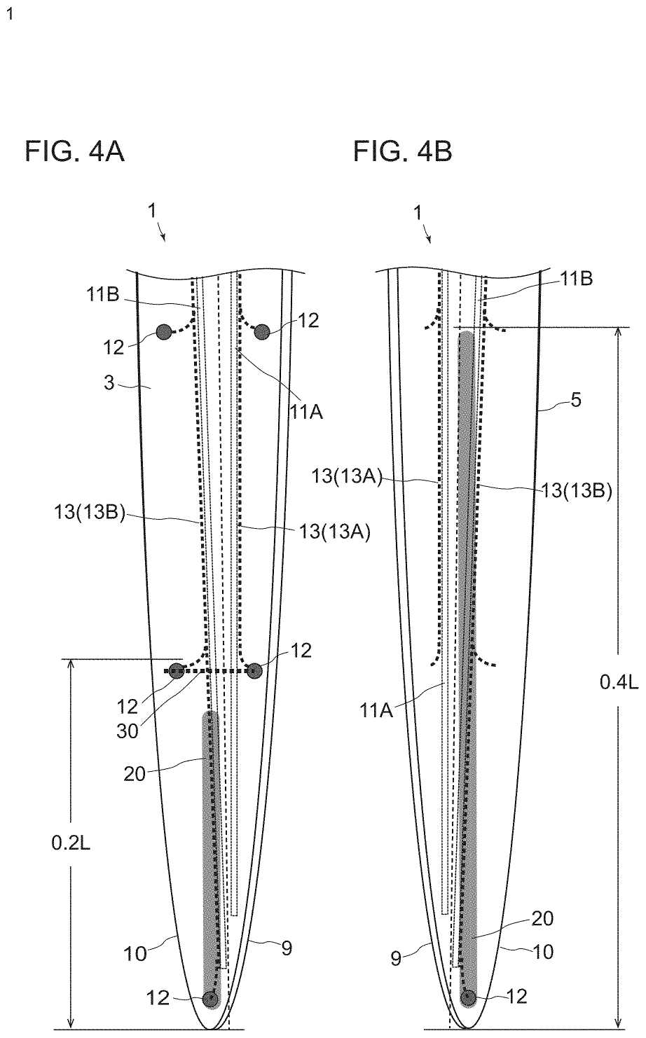

FIG. 4A and FIG. 4B are schematic views illustrating a configuration example of a wind turbine blade protection structure according to another embodiment, FIG. 4A illustrating a suction surface and FIG. 4B illustrating a pressure surface.

As illustrated in FIG. 4A and FIG. 4B in a non-limiting manner, the at least one metal receptor 12 may include a plurality of metal receptors 12 disposed at least on: the blade tip portion 8 on the side of the pressure surface 4 of the wind turbine blade 3; the blade tip portion 8 on a side of the suction surface 5 of the wind turbine blade 3, and a plurality of locations arranged at an interval along the leading edge 9 or the trailing edge 10 of the wind turbine blade 3 from the blade tip portion 8 (for example, see FIG. 3A and FIG. 3B).

The metal thin layer 20 on the side of the pressure surface 4 may be disposed within a range not greater than 40% of the blade length L from the blade tip 8A of the wind turbine blade 3 including the metal receptor 12 disposed on the blade tip portion 8 (for example, see FIG. 3B), and the metal thin layer 20 on the side of the suction surface 5 may be disposed within a range smaller than 20% of the blade length L along the blade longitudinal direction from the blade tip 8A including the metal receptor 12 disposed on the blade tip portion 8 (for example, see FIG. 3A).

With this configuration, the metal thin layer 20 disposed within the range not greater than 40% of the blade length L from the blade tip 8A on the pressure surface 4 side of the wind turbine blade 3 can expand a lightning receivable range where the lightning current of lighting within the range can be guided from the metal receptor 12 disposed in the blade tip portion 8 to the down-conductor 13. Lightning can be appropriately captured by the plurality of metal receptors 12 disposed at an interval along the leading edge 9 or the trailing edge 10 on the side of the suction surface 5 of the wind turbine blade 3 and the metal thin layer 20 disposed within the range of 20% of the blade length L from the blade tip 8A including the metal receptor 12 disposed on the blade tip portion 8.

In some embodiments, a diverter strip 30 (segmented diverter strip: SDS) may be disposed on the suction surface 5 of the wind turbine blade 3 the diverter strip being configured to be capable of electrically connecting two of the at least one metal receptor 12 disposed on the leading-edge 9 side and the trailing-edge 10 side upon lightning strike (for example, see FIG. 3A and FIG. 4A).

As described above, the diverter strip 30 is disposed between the two metal receptors 12 disposed on the leading-edge 9 side and the trailing-edge 10 side on the suction surface 5 of the wind turbine blade 3. Air around this diverter strip 30 is ionized upon lightning strike, and the lightning current flows along the surface 6 of the wind turbine blade 3 via the diverter strip 30 to be guided to the metal receptor 12. Thus, no lightning conductor needs to be provided for the diverter strip 30, whereby lightning resistance performance of the wind turbine blade 3 can be improved with a simple structure.

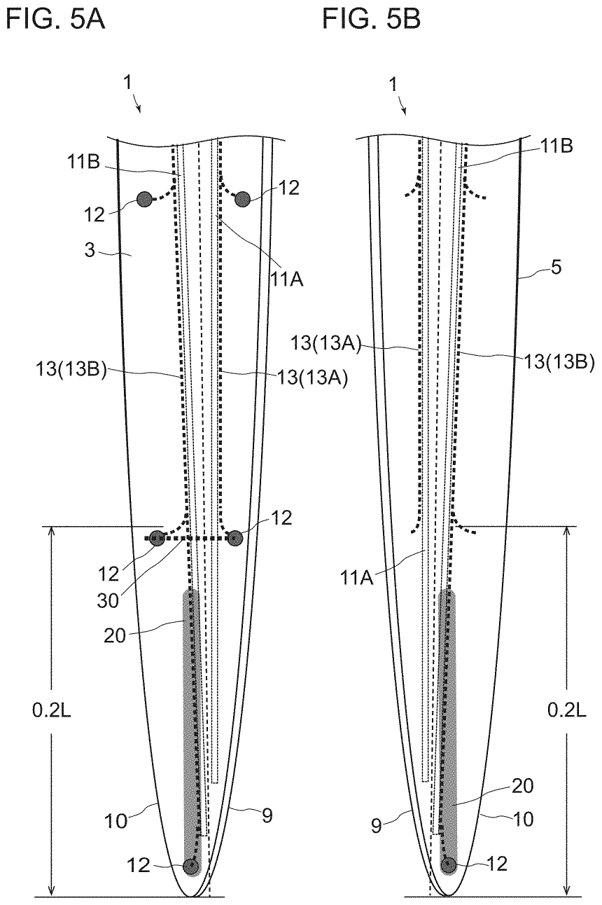

In some embodiments, the diverter strip 30 may be disposed on the suction surface 5 of the wind turbine blade 3, the diverter strip 30 being configured to be capable of electrically connecting two of the at least one metal receptor 12 disposed on the leading-edge 9 side and the trailing-edge 10 side upon lightning strike, and the metal thin layer 20 on the side of the suction surface 5 may be disposed on a position separated from the diverter strip 30 by at least one meter (for example, see FIG. 4A and FIG. 5A).

With this configuration, as described above, the diverter strip 30 enables the lightning resistance performance of the wind turbine blade 3 to be improved with a simple structure. In addition, the metal thin layer 20 on the side of the suction surface 5 is disposed on a position separated from the diverter strip 30 by at least one meter. This configuration can prevent spark, due to the lightning current jumping to the metal receptor 12 disposed on a portion other than the blade tip portion 8 from the metal thin layer 20 on the side of the suction surface 5, and the like.

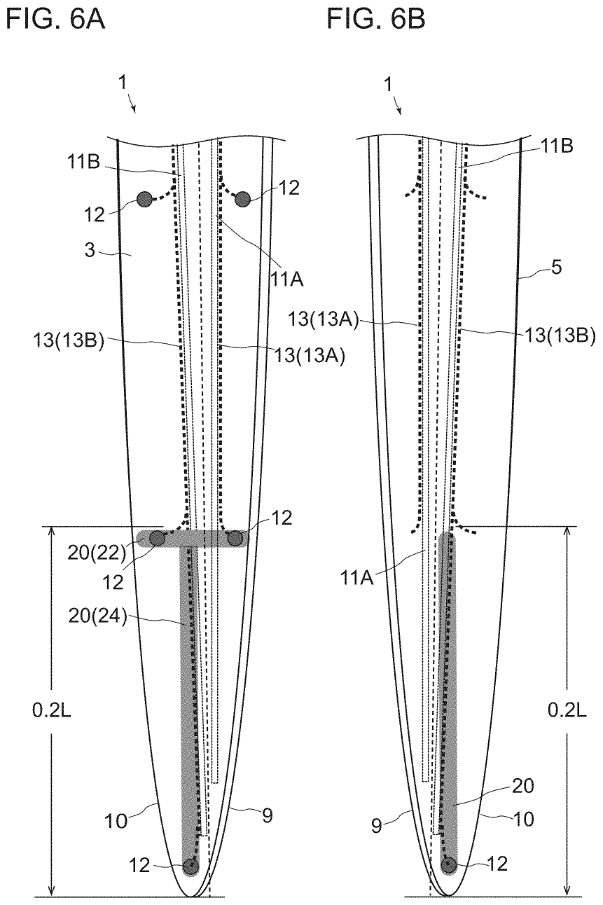

FIG. 6A and FIG. 6B are schematic views illustrating a configuration example of a wind turbine blade protection structure according to another embodiment, FIG. 6A illustrating a suction surface and FIG. 6B illustrating a pressure surface.

As illustrated in FIG. 6A and FIG. 6B in a non-limiting manner, in some embodiments, the at least one metal receptor 12 may include a plurality of metal receptors 12 disposed at least on: the blade tip portion 8 on the side of the pressure surface 4; the blade tip portion 8 on a side of the suction surface 5 of the wind turbine blade 3; and a plurality of locations arranged at an interval along the leading edge 9 and the trailing edge 10 of the wind turbine blade 3 from the blade tip portion 8.

The metal thin layer 20 on the side of the pressure surface 4 may be disposed within a range not greater than 20% of the blade length L from the blade tip 8A of the wind turbine blade 3 along the blade longitudinal direction from the metal receptor 12 disposed on the blade tip portion 8 on the side of the pressure surface 4 (for example, see FIG. 6B), the metal thin layer 20 on the side of the suction surface 5 may be disposed over a first range 22 where two of the metal receptors 12 disposed on the leading-edge 9 side and the trailing-edge 10 side are electrically connected in a range smaller than 20% of the blade length L from the blade tip 8A, and a second range 24 extending along the blade longitudinal direction from the metal receptor 12 disposed on the blade tip portion 8 so as to at least partially overlap with the first range 22 (for example, see FIG. 6A).

The first range 22 and the second range 24 may be provided to cross each other to form a T shape.

With this configuration, lightning can be captured by the metal thin layer 20 that is disposed within a range not greater than 20% of the blade length L from the blade tip 8A of the wind turbine blade 3 along the blade longitudinal direction from the metal receptor 12 disposed on the blade tip portion 8 on the side of the pressure surface 4 of the wind turbine blade 3. The resultant lightning current can be guided to the down-conductor 13 through the metal receptor 12. Furthermore, the lightning capture rate can further be improved with the metal thin layer 20 on the side of the suction surface 5 that is disposed over the first range 22 where two of the metal receptors 12 disposed on the leading-edge 9 side and the trailing-edge 10 side are electrically connected and the second range 24 extending along the blade longitudinal direction from the metal receptor 12 disposed on the blade tip portion 8 so as to at least partially overlap with the first range 22.

In some embodiments, the wind turbine blade protection structure 1 may further include a leading-edge side shear web 11A and a trailing-edge side shear web 11B each extending along the blade longitudinal direction inside the wind turbine blade 3 and connecting the pressure surface 4 and the suction surface 5 of the wind turbine blade 3 (see FIG. 3A and FIG. 3B to FIG. 6A and FIG. 6B).

The trailing-edge side shear web 11B may be disposed closer to a center from the leading-edge side shear web 11A in a chordwise direction of the wind turbine blade 3, the trailing-edge side shear web 11B extending closer to the blade tip 8A than the leading-edge side shear web 11A. The wind turbine blade 3 has a blade shape with a thickness on the side of the leading edge 9 being larger than that on the side of the trailing edge 10. Thus, the trailing-edge side shear web 11B is disposed closer to the chord center than the leading-edge side shear web 11A is, and thus extends to be closer to the blade tip 8A than the leading-edge side shear web 11A is.

The at least one metal receptor 12 may include a plurality of metal receptors 12 disposed at an interval along each of the leading-edge 9 side and the trailing-edge 10 side of the suction surface 5.

The down-conductor 13 may include a first down-conductor 13A disposed along the leading-edge side shear web 11A, and a second down-conductor 13B disposed along the trailing-edge side shear web 11B (see FIG. 3A and FIG. 3B to FIG. 6A and FIG. 6B).

This configuration includes the two down-conductors 13, namely, the first down-conductor 13A and the second down-conductor 13B, to ensure a plurality of paths for guiding the lightning current along the blade longitudinal direction to be provided in the wind turbine blade 3. The second down-conductor 13B extends to the blade tip 8A along the trailing-edge side shear web 11B, and may be electrically connected to the metal receptor 12 at the blade tip portion 8. With this configuration, for example, the metal receptors 12 on the leading-edge 9 side are connected to the first down-conductor 13A and the metal receptors 12 on the trailing-edge 10 side are connected to the second down-conductor 13B, on the side of the suction surface 5 of the wind turbine blade 3. Thus, the lightning current can be more smoothly guided.

In some embodiments, the at least one metal receptor 12 may be formed so as to have a protruding height of not greater than 3 mm from the blade surface 6 of the wind turbine blade 3. With this configuration, the metal receptor 12 has a small impact on the aerodynamics of the wind turbine blade 3. Thus, the lightning resistance performance can be improved with a small impact on an operation performance of the wind turbine 2.

In some embodiments, the metal thin layer 20 may include a metal tape, a metal mesh, or a metal layer. The effect described in relation to any one of the above-described configurations can be obtained with the metal thin layer 20 including a metal tape, a metal mesh, or a metal layer.

In some embodiments, the metal thin layer 20 may be formed so as to have an area occupying the blade surface 6 of the wind turbine blade 3, the area being not smaller than ten times an area of the metal receptor 12 to which the metal thin layer 20 is to be connected.

With this configuration, the lightning receivable range of lightning at least in the blade tip portion 8 can be expanded to be not smaller than ten times an area with the metal receptor 12 alone. Thus, the lightning capture rate can be largely improved at the blade tip portion 8, which is likely to be struck by lightning.

In some embodiments, the metal thin layer 20 has a width of from 50 to 300 mm.

With this configuration, the effect described in relation to any one of the configurations can be obtained with the metal thin layer having a width of from 50 to 300 mm

In some embodiments, the metal thin layer 20 may have a thickness of from 50 to 300 μm. With this configuration, the metal thin layer 20 has a thickness of from 50 to 300 μm to have the smallest possible impact on the aerodynamics of the wind turbine blade 3. Thus, the lightning resistance performance can be improved with a small impact on the operation performance of the wind turbine 2.

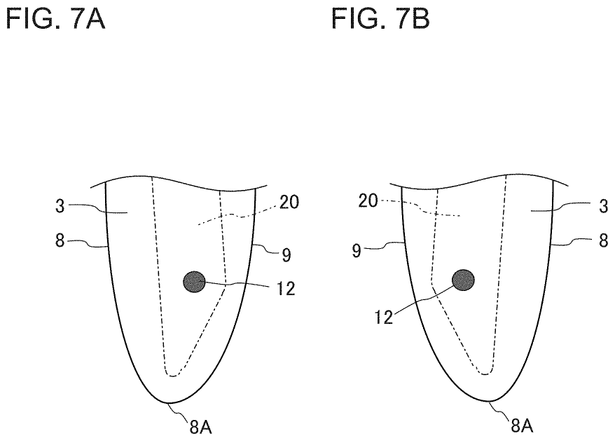

For example, as illustrated in FIG. 7A and FIG. 7B, the metal thin layer 20 may extend further toward the blade tip 8A than the metal receptor 12 is. With this configuration the lightning receivable range of the metal receptor 12 can be extended toward the blade tip 8A as much as possible.

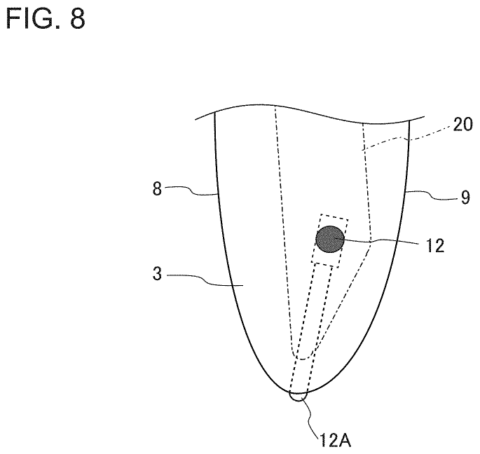

In some embodiments, as illustrated in FIG. 8 in a non-limiting manner, the metal receptor 12 disposed in the blade tip portion 8 is exposed on the blade surface 6, and may include a rod receptor 12A that is connected with the exposed portion inside the wind turbine blade 3 and extends to the blade tip 8A. The rod receptor 12A may have a tip exposed to the outside from the blade tip 8A. With this configuration, the lightning receivable range can be expanded to the blade tip 8A that is a portion of the wind turbine blade 3 with a high risk of being struck by lightning.

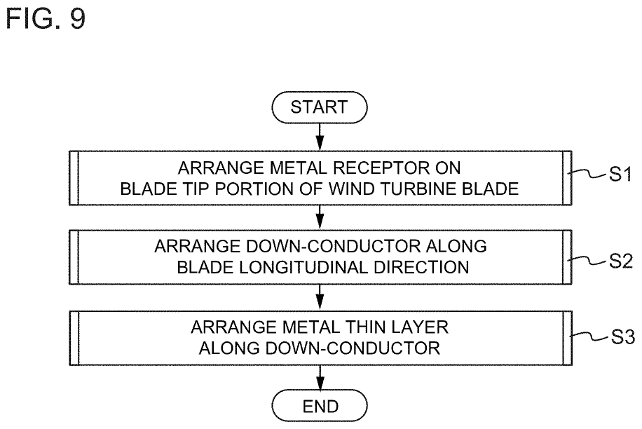

Next, a method of forming a wind turbine blade protection structure according to at least one embodiment of the disclosure is described in detail with reference to FIG. 9.

FIG. 9 is a flowchart illustrating a method of forming a wind turbine blade protection structure according to another embodiment.

As illustrated in FIG. 9 in a non-limiting manner, a method of forming a wind turbine blade protection structure according to at least one embodiment of the disclosure is a method of forming a wind turbine blade protection structure for protecting the wind turbine blade 3 from lightning, the method including: a step of arranging at least one metal receptor 12 at least on the blade tip portion 8 of the wind turbine blade 3 so that at least a part of the metal receptor 12 is exposed on the surface 6 of the wind turbine blade 3 (step S1); a step of arranging the down-conductor 13 electrically connected to each of the at least one metal receptor 12 along the blade longitudinal direction from the metal receptor 12 to the blade root portion 7 inside the wind turbine blade 3 (step S2); and a step of arranging the metal thin layer 20 so as to cover at least a part of a surface of the wind turbine blade 3 so that at least a part of the metal thin layer 20 is electrically connected to the at least one metal receptor 12 (step S3).

Step S3 of arranging the metal thin layer 20 includes arranging at least the metal thin layer 20, disposed on the side of the pressure surface 4 of the wind turbine blade 3, along the down-conductor 13 in the blade longitudinal direction of the wind turbine blade 3.

As described above, the metal receptor 12 is disposed such that at least a part of the at least one metal receptor 12 is exposed on a surface 6 of the wind turbine blade 3, and the metal thin layer 20 is disposed so as to cover at least a part of the surface 6, at least a part of the metal thin layer 20 being electrically connected to the metal receptor 12. Thus, when the metal thin layer 20 is struck by lightning, the resultant lightning current is guided from the metal thin layer 20 to the metal receptor 12 and is guided to the blade root portion 7 through the down-conductor 13 electrically connected to the metal receptor 12. Thus, even when a portion other than the metal receptor 12 is struck by lightning, the current of the lightning can be smoothly guided. The metal thin layer 20 disposed at least on the side of the pressure surface 4 of the wind turbine blade 3 is arranged along the down-conductor 13 that finally guides the lightning current, and thus a lightning capture rate can be improved.

With at least one embodiment of the disclosure described above, even when a portion other than the metal receptor 12 is struck by lightning, the current of the lightning can be smoothly guided.

It should be noted that the disclosure is not limited to the embodiments described above and also includes embodiments with modifications to the embodiments described above and a combination of these embodiments.

1. A wind turbine blade protection structure for protecting a wind turbine blade from lightning, comprising:
at least one metal receptor disposed at least on a blade tip portion of the wind turbine blade such that at least a part of the at least one metal receptor is exposed on a surface of the wind turbine blade;
a down-conductor extending along a blade longitudinal direction from the metal receptor to a blade root portion inside the wind turbine blade, the down-conductor being electrically connected to each of the at least one metal receptor; and
a metal thin layer disposed so as to cover at least a part of the surface of the wind turbine blade, at least a part of the metal thin layer being electrically connected to the metal receptor,
wherein the metal thin layer disposed at least on a side of a pressure surface of the wind turbine blade is arranged along the down-conductor in the blade longitudinal direction of the wind turbine blade.

2. The wind turbine blade protection structure according to claim 1,
wherein the at least one metal receptor includes a plurality of metal receptors disposed at least on: the blade tip portion on the side of the pressure surface of the wind turbine blade; the blade tip portion on a side of a suction surface of the wind turbine blade; and a plurality of locations arranged at an interval along a trailing edge of the wind turbine blade from the blade tip portion, and
wherein the metal thin layer is disposed within a range not greater than 40% of a blade length of the wind turbine blade along the blade longitudinal direction, from the metal receptor disposed on the blade tip portion on the pressure surface or the suction surface on which the metal thin layer is disposed.

3. The wind turbine blade protection structure according to claim 1,
wherein the metal thin layer on a side of a suction surface of the wind turbine blade is disposed closer to a trailing edge with respect to a chord center of the wind turbine blade, within a range not greater than 40% of a blade length from the blade tip portion on the side of the suction surface.

4. The wind turbine blade protection structure according to claim 3,
wherein the metal thin layer on the side of the suction surface of the wind turbine blade is disposed so as to electrically connect at least a part of the plurality of metal receptors disposed on a plurality of locations arranged at an interval along a leading edge or the trailing edge of the wind turbine blade.

5. The wind turbine blade protection structure according to claim 1,
wherein the at least one metal receptor includes a plurality of metal receptors disposed at least on: the blade tip portion on the side of the pressure surface of the wind turbine blade; the blade tip portion on a side of a suction surface of the wind turbine blade, and a plurality of locations arranged at an interval along a leading edge or a trailing edge of the wind turbine blade from the blade tip portion, and
wherein the metal thin layer on the side of the pressure surface is disposed within a range not greater than 40% of a blade length from a blade tip of the wind turbine blade including the metal receptor disposed on the blade tip portion, and
wherein the metal thin layer on the side of the suction surface is disposed within a range smaller than 20% of the blade length along the blade longitudinal direction from the blade tip including the metal receptor disposed on the blade tip portion.

6. The wind turbine blade protection structure according to claim 1, further comprising a diverter strip disposed on a suction surface of the wind turbine blade and is configured to be capable of electrically connecting two of the at least one metal receptor disposed on a leading-edge side and a trailing-edge side upon lightning strike.

7. The wind turbine blade protection structure according to claim 5, further comprising a diverter strip disposed on a suction surface of the wind turbine blade and is configured to be capable of electrically connecting two of the at least one metal receptor disposed on a leading-edge side and a trailing-edge side upon lightning strike,
wherein the metal thin layer on the side of the suction surface is disposed on a position separated from the diverter strip by at least one meter.

8. The wind turbine blade protection structure according to claim 1,
wherein the at least one metal receptor includes a plurality of metal receptors disposed at least on: the blade tip portion on the side of the pressure surface; the blade tip portion on a side of a suction surface of the wind turbine blade; and a plurality of locations arranged at an interval along a leading edge and a trailing edge of the wind turbine blade from the blade tip portion,
wherein the metal thin layer on the side of the pressure surface is disposed within a range not greater than 20% of a blade length from a blade tip of the wind turbine blade along the blade longitudinal direction from the metal receptor disposed on the blade tip portion on the side of the pressure surface, and
wherein the metal thin layer on the side of the suction surface is disposed over a first range where two of the metal receptors disposed on a leading-edge side and a trailing-edge side are electrically connected in a range smaller than 20% of the blade length from the blade tip, and a second range extending along the blade longitudinal direction from the metal receptor disposed on the blade tip portion so as to at least partially overlap with the first range.

9. The wind turbine blade protection structure according to claim 1,
further comprising a leading-edge side shear web and a trailing-edge side shear web each extending along the blade longitudinal direction inside the wind turbine blade and connecting the pressure surface and a suction surface of the wind turbine blade,
wherein the trailing-edge side shear web is disposed closer to a center from the leading-edge side shear web in a chordwise direction of the wind turbine blade, the trailing-edge side shear web extending closer to the blade tip than the leading-edge side shear web,
wherein the at least one metal receptor includes a plurality of metal receptors disposed at an interval along each of the leading-edge side and the trailing-edge side of the suction surface, and
wherein the down-conductor includes a first down-conductor disposed along the leading-edge side shear web, and a second down-conductor disposed along the trailing-edge side shear web.

10. The wind turbine blade protection structure according to claim 1,
wherein the at least one metal receptor is formed so as to have a protruding height of not greater than 3 mm from a blade surface of the wind turbine blade.

11. The wind turbine blade protection structure according to claim 1,
wherein the metal thin layer includes a metal tape, a metal mesh, or a metal layer.

12. The wind turbine blade protection structure according to claim 1,
wherein the metal thin layer is formed so as to have an area occupying a blade surface of the wind turbine blade, the area being not smaller than ten times an area of the metal receptor to which the metal thin layer is to be connected.

13. The wind turbine blade protection structure according to claim 1,
wherein the metal thin layer has a width of from 50 to 300 mm.

14. The wind turbine blade protection structure according to claim 1,
wherein the metal thin layer has a thickness of from 50 to 300 μm.

15. A method of forming a wind turbine blade protection structure for protecting a wind turbine blade from lightning, the method comprising:
a step of arranging at least one metal receptor at least on a blade tip portion of the wind turbine blade so that at least a part of the metal receptor is exposed on a surface of the wind turbine blade;
a step of arranging a down-conductor electrically connected to each of the at least one metal receptor along a blade longitudinal direction from the metal receptor to a blade root portion inside the wind turbine blade; and
a step of arranging a metal thin layer so as to cover at least a part of a surface of the wind turbine blade so that at least a part of the metal thin layer is electrically connected to the at least one metal receptor,
wherein the step of arranging the metal thin layer includes arranging the metal thin layer disposed at least on a side of a pressure surface of the wind turbine blade along the down-conductor in the longitudinal direction of the wind turbine blade.
